(19) United States
(12) Patent Application Publication
(10) Pub. No.: US 2026/0249614 A1
(43) Pub. Date: Aug. 27, 2026

(54) PRINTER AND MAINTENANCE METHOD

(71) Applicant: SCREEN Holdings Co., Ltd., Kyoto (JP)

(72) Inventors: Shohei KOZUKA, Kyoto-shi (JP); Hiroyuki KAJIYA, Kyoto-shi (JP)

(21) Appl. No.: 19/443,318

(22) Filed: Jan. 8, 2026

(30) Foreign Application Priority Data
Feb. 25, 2025 (JP) 2025-028020

(51) Int. Cl. B41J 2/165; B41J 2/175; B41J 2/18

(52) U.S. Cl. CPC B41J 2/16552; B41J 2/16532; B41J 2/17596; B41J 2/18; B41J 2002/16558; B41J 2002/16594

(57) ABSTRACT

A printer includes a head that ejects ink, and a maintenance unit for maintenance of the head. The maintenance unit includes a cleaning block and a wiper. In a maintenance process, a controller performs a cleaning process of causing the cleaning block to supply a cleaning liquid to a nozzle surface and to suck in a liquid adhering to the nozzle surface, and a wiping process of causing the wiper to wipe off the nozzle surface. The controller keeps the pressure in the nozzle at a first pressure during printing and keeps the pressure in the nozzle at a wiping pressure during the cleaning process and the wiping process. The wiping pressure is higher than the first pressure and lower than a second pressure under which the ink adheres to the wiper during the wiping process. Accordingly, the nozzle surface is wiped off under appropriate conditions.

### RELATED APPLICATIONS

This application claims the benefit of Japanese Application No. 2025-028020, filed on February 25, 2025, the disclosure of which is incorporated by reference herein.

### BACKGROUND OF THE INVENTION

### FIELD OF THE INVENTION

The present invention relates to technology for performing maintenance of heads in a printer that performs inkjet printing on a long strip printing medium.

### Description of the Background Art

Printers that eject ink on a surface of a long strip printing medium to form an image on the printing medium while transporting the printing medium in a longitudinal direction are conventionally known. The printers include heads, each having a plurality of nozzles for ejecting ink.

The printers of this type may wipe off the lower surfaces of the heads with the nozzles (hereinafter referred to as “nozzle surfaces”) so as to remove the ink or the like adhering to the nozzle surfaces.

Such a conventional printer that wipes off the nozzle surfaces is described in, for example, Japanese Patent Application Laid-Open No. 2024-9618.

However, if the negative pressure of the meniscus at each nozzle of the heads is low during the wiping off of the nozzle surface, ink leakage from the inside of the nozzle may adhere to the wiper, and the nozzle surface may be wiped off with the wiper having the ink adhering thereto. In that case, the nozzle surface may wear out depending on the type of the ink.

On the other hand, if the negative pressure of the meniscus at each nozzle of the heads is high during the wiping off of the nozzle surface, the wiping with the wiper may cause the intrusion of air into the nozzle, resulting in ejection failures. In the case where a cleaning liquid is supplied to the nozzle surface before the wiping with the wiper, the wiping with the wiper may cause the intrusion of not only air but also the cleaning liquid into the nozzle. Here, the phrase “the negative pressure of the meniscus is low” means that the absolute value of the negative pressure is small, and the phrase “the negative pressure of the meniscus is high” means that the absolute value of the negative pressure is large.

### SUMMARY OF THE INVENTION

The present invention has been made in light of such circumstances, and it is an object of the present invention to provide a technique that enables wiping off of a nozzle surface under appropriate conditions.

A first aspect of the present application is a printer that performs inkjet printing on a printing medium. The printer includes a head having a plurality of nozzles for ejecting ink, a maintenance unit that performs maintenance of the head, and a controller that regulates a pressure in the head and controls an operation of the maintenance unit. The head has a lower surface that includes a nozzle surface where the plurality of nozzles are provided. The maintenance unit includes a cleaning block that includes a supplying hole and a suction hole, the supplying hole being a hole through which a cleaning liquid is ejected to the nozzle surface, the suction hole being a hole through which a liquid adhering to the nozzle surface is sucked in, and a wiping unit that includes a wiper that comes in contact with the nozzle surface. In a maintenance process, the controller a) causes the cleaning block to supply the cleaning liquid to the nozzle surface through the supplying hole and to suck in a liquid adhering to the nozzle surface through the suction hole, and b) causes the wiper to wipe off the nozzle surface after the operation a). The controller keeps a pressure in the nozzle at a predetermined first pressure during a printing process. The controller keeps the pressure in the nozzle at a predetermined wiping pressure during the operations a) and b). The predetermined wiping pressure is higher than the predetermined first pressure and lower than a second pressure under which the ink adheres to the wiper during the operation b).

A second aspect of the present application is the printer according to the first aspect that further includes an ink tank that supplies the ink to the head, and an ink circulation passage in which the ink is circulated between the ink tank and the head. The controller is capable of controlling a flow rate of the ink in the ink circulation passage. The controller continues the circulation of the ink in the ink circulation passage during the printing process. The controller stops the circulation of the ink in the ink circulation passage during the maintenance process.

A third aspect of the present application is the printer according to the second aspect that further includes a supply pressure regulator and a recovery pressure regulator. The ink circulation passage includes a supply reservoir that supplies the ink to the head, a recovery reservoir that recovers the ink from the head, piping that connects the recovery reservoir and the supply reservoir, and a pump that is interpolated in the piping and sends the ink from the recovery reservoir to the supply reservoir. The supply pressure regulator communicates with a gas layer formed in the supply reservoir through supply pressure piping and keeps a pressure in the supply reservoir at a predetermined negative pressure for the supply reservoir. The recovery pressure regulator communicates with a gas layer formed in the recovery reservoir through recovery pressure piping and keeps a pressure in the recovery reservoir at a predetermined negative pressure for the recovery reservoir. The controller controls the supply pressure regulator and the recovery pressure regulator to average the predetermined negative pressure for the supply reservoir and the predetermined negative pressure for the recovery reservoir and to stop the circulation of the ink in the ink circulation passage by stopping the pump during the maintenance process.

A fourth aspect of the present application is the printer according to the third aspect, in which the wiping unit further includes a cleaning-liquid ejection nozzle that ejects the cleaning liquid to the wiper, and the nozzle surface is wiped off with the wiper having the cleaning liquid adhering thereto, during the wiping process.

A fifth aspect of the present application is the printer according to the fourth aspect, in which the wiping pressure is a pressure under which the ink is not sucked in through the nozzle against a suction pressure developed in the suction hole during the cleaning process.

A sixth aspect of the present application is the printer according to the first aspect, in which the nozzle surface is formed of a silicon member.

A seventh aspect of the present application is the printer according to the sixth aspect, in which the nozzle surface is a surface obtained by forming a water-repellent film on a surface of the silicon member.

An eighth aspect of the present application is the printer according to the first aspect, in which the ink is pigment ink that contains titanium oxide or carbon.

A ninth aspect of the present application is the printer according to the first aspect, in which the wiper is biased toward the nozzle surface by an elastic spring during the operation b).

A tenth aspect of the present application is the printer according to any one of the first to ninth aspects, in which the predetermined wiping pressure is higher than or equal to 0.40P₁ and lower than or equal to 0.21P₁, where P₁ is the predetermined first pressure that is a negative pressure.

An eleventh aspect of the present application is a maintenance method of performing maintenance of a head in a printer that performs inkjet printing on a printing medium. The maintenance method includes, under control of the controller, a) causing a cleaning block to supply a cleaning liquid to a nozzle surface and suck in a liquid adhering to the nozzle surface, and b) causing a wiper to wipe off the nozzle surface after the operation a). The nozzle surface is a lower surface of the head where a plurality of nozzles for ejecting ink are provided. A pressure in the nozzle is kept at a predetermined wiping pressure during the operations a) and b). The predetermined wiping pressure is higher than a first pressure and lower than a second pressure, the first pressure being a pressure in the nozzle during a printing process, the second pressure being a pressure under which the ink adheres to the wiper during the operation b).

According to the first to eleventh aspects of the present application, it is possible to suppress the adhesion of the ink to the wiper and the intrusion of air and the cleaning liquid into the nozzles when the nozzle surface is wiped off with the wiper.

According to the second aspect of the present application, since the maintenance process is performed while the circulation of the ink in the ink circulation passage is stopped, it is possible to suppress the intrusion of the cleaning liquid and foreign materials into the ink circulation passage during maintenance.

According to the third aspect of the present application, since the flow of the ink in the head is stopped smoothly, it is possible to reliably prevent the destruction of the meniscus during transition from the printing process to the maintenance process.

According to the fourth aspect of the present application, since the nozzle surface is wiped off with the wiper having the cleaning liquid adhering thereto, it is possible to reduce the frictional force acting between the wiper and the nozzle surface.

According to the fifth aspect of the present application, it is possible to reliably prevent the ink from being sucked out from the nozzles during the cleaning process.

According to the sixth aspect of the present application, it is possible to prevent the wiper having the ink adhering thereto from coming into contact with the nozzle surface. This makes the nozzle surface to be less likely to wear out even if the nozzle surface is formed of a material other than a rigid body.

According to the seventh aspect of the present application, it is possible to prevent the wiper having the ink adhering thereto from coming into contact with the nozzle surface. Thus, even if the nozzle surface is covered with a water-repellent film, the nozzle surface is useful because the water-repellent film is not easily worn out.

According to the eighth aspect of the present application, it is possible to prevent the wiper having the ink adhering thereto from coming into contact with the nozzle surface. Accordingly, the nozzle surface is less likely to wear out and is thus useful even if the ink contains titanium oxide or carbon that easily causes the nozzle surface to wear out.

According to the ninth aspect of the present application, the wiper can be brought into intimate contact with the nozzle surface.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing a configuration of a printing system.

FIG. 2 is a diagram showing a configuration of a printer.

FIG. 3 is a bottom view of a head unit.

FIG. 4 is a diagram showing configurations of the head unit, a maintenance unit, and a movement mechanism.

FIG. 5 is a perspective view of a cleaning block.

FIG. 6 is a top view of the cleaning block.

FIG. 7 is a diagram showing a configuration of a wiping unit.

FIG. 8 is a flowchart showing a process procedure for maintenance of the head unit.

FIG. 9 is a diagram showing an ink suction process.

FIG. 10 is a diagram showing a cleaning process and a wiping process.

FIG. 11A is a diagram schematically showing a liquid level of ink in a nozzle after the cleaning process and before the wiping process.

FIG. 11B is a diagram schematically showing a liquid level of ink in a nozzle after the cleaning process and before the wiping process.

FIG. 11C is a diagram schematically showing a liquid level of ink in a nozzle after the cleaning process and before the wiping process.

FIG. 12 is a diagram showing the result of experiment on the adhesion of ink to a wiper and the occurrence of failing nozzles after the cleaning process and the wiping process.

### DESCRIPTION OF THE PREFERRED EMBODIMENTS

### 1. CONFIGURATION OF PRINTER

Hereinafter, an embodiment of the present invention is described with reference to the drawings.

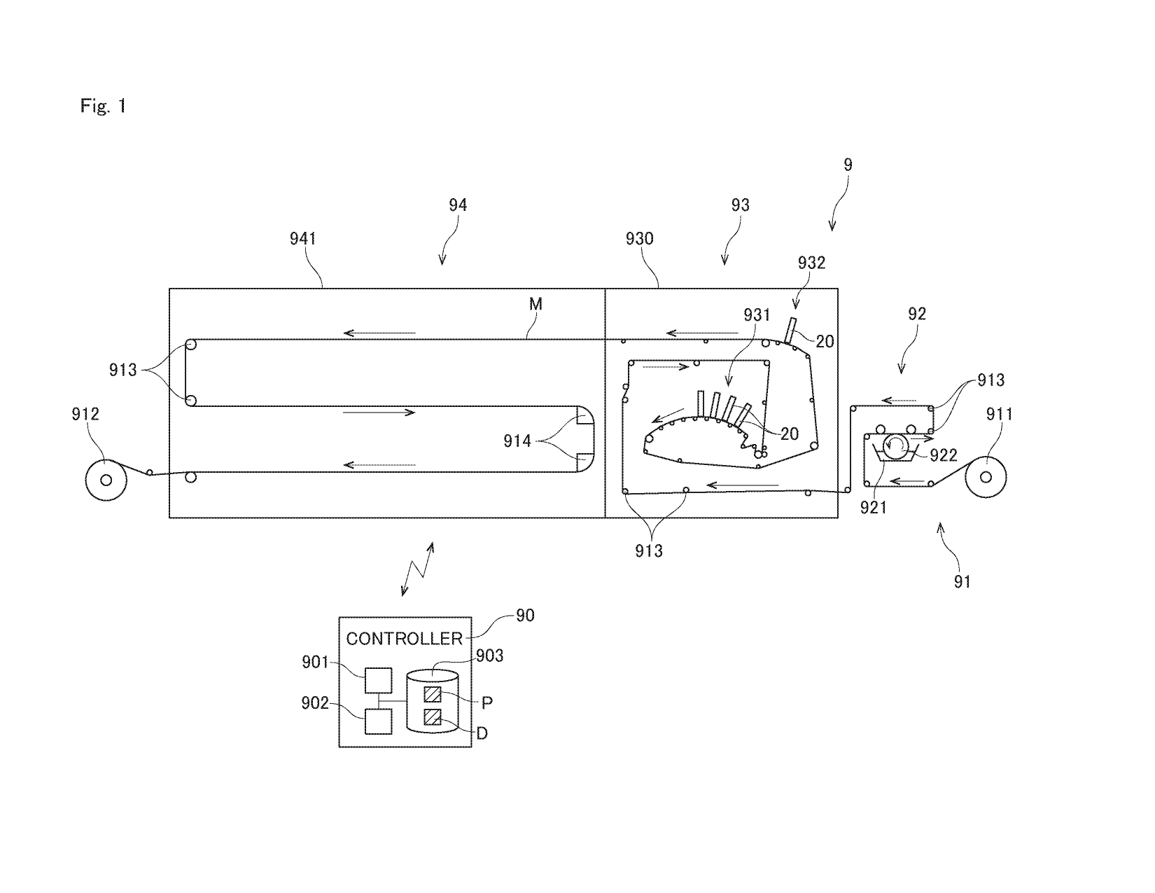

A printer 9 using an ink tank 25 according to one embodiment of the present invention is described hereinafter with reference to FIG. 1. FIG. 1 is a schematic view of the printer 9. The printer 9 performs coating processing, print processing, and dry processing on a long strip printing medium M while transporting the printing medium M under the control of a controller 90 that controls each component of the printer.

Specifically, the printer 9 is a printer that ejects ink droplets of watercolor pigment ink by an inkjet method on a long strip film sheet for use in flexible packaging. Note that the raw material for the printing medium M may be a film of, for example, oriented polypropylene (OPP) or polyethylene terephthalate (PET). The raw material for the printing medium M is, however, not limited to a resinous film, and may be any other raw material such as paper. Out of the two surfaces of the printing medium M, the surface on which an image is printed is referred to as the front side, and the surface on the side opposite to the front side is referred to as the back side.

The printer 9 includes a transport mechanism 91, a coating processing unit 92, a print processing unit 93, and a dry processing unit 94.

The transport mechanism 91 is a device for transporting the printing medium M along a predetermined transport path. The transport mechanism 91 includes a feed roller 911, a take-up roller 912, and a larger number of other transport rollers 913. The feed roller 911, the take-up roller 912, and some of the transport rollers 913 are rotary rollers that are rotated by a motor or the like. Another some of the transport rollers 913 are idler rollers that rotate in accordance with the movement of the printing medium M.

When the printer 9 is driven, the feed roller 911, the take-up roller 912, and the rotary rollers which are some of the transport rollers 913 are rotated so that the printing medium M is fed out from the feed roller 911, and after execution of the coating processing by the coating processing unit 92, the print processing by the print processing unit 93, and the dry processing by the dry processing unit 94, the printing medium M is taken up by the take-up roller 912. In FIG. 1, arrows indicating the transport direction are shown on the front side of the printing medium M.

The coating processing unit 92 is a device for applying a liquefied primer (coating liquid) to the front side of the printing medium M. The coating processing unit 92 includes a pan 921 and a gravure roller 922. The pan 921 stores the liquefied primer. The gravure roller 922 is a roller for applying the primer to the front side of the printing medium M that is being transported by the transport mechanism 91. The gravure roller 922 is arranged so as to be immersed in part in the primer stored in the pan 921.

The gravure roller 922 rotates relative to the printing medium M that is being transported with the front side facing down, while holding the primer on the outer peripheral surface so as to apply the primer to the front side of the printing medium M. Note that the direction of travel of the printing medium M and the direction of rotation of the gravure roller 922 are opposite directions. The direction of rotation of the gravure roller 922 is indicated by an arrow in FIG. 1. That is, the gravure roller 922 applies the primer to the front side of the printing medium M by a so-called reverse kiss coating method.

The print processing unit 93 includes a case 930, a color printer 931, and a white printer 932. The color printer 931 and the white printer 932 are arranged inside the case 930. The color printer 931 ejects a plurality of colors of ink from above to the printing medium M that is being transported with the front side facingup . In the present embodiment, the color printer 931 includes four head units 20 for ejecting different colors (process colors) of ink other than white. The ink colors ejected from the color printer 931 are, for example, cyan, magenta, yellow, and black. The white printer 932 ejects white ink from above to the printing medium M that is being transported with the front side facing up. The white printer 932 includes one head unit 20 for ejecting white ink.

Detailed configurations of the head units 20 and an ink supplier 40 will be described later, the ink supplier being a device for supplying ink to the heads 21 of the head units 20.

The print processing unit 93 further includes a pre-dryer (not shown) that dries the ink ejected to the front side of the printing medium M, on the side downstream of the color printer 931 and upstream the white printer 932, and another pre-dryer (not shown) on the side downstream of the white printer 932.

The dry processing unit 94 is a device that dries the ink ejected to the front side of the printing medium M in the print processing unit 93. The dry processing unit 94 includes a drying oven 941 that is a casing. The transport path for the printing medium M, formed by the transport mechanism 91 inside the drying oven 941, has an S-letter shape. Note that the transport mechanism 91 includes air turn bars 914, instead of the transport rollers 913, at positions that come into contact with the front side of the printing medium M within the drying oven 941.

The controller 90 is configured as, for example, a computer that includes a processor 901 such as a CPU, memory 902 such as RAM, and storage 903 such as a hard disk drive. The storage 903 stores computer programs P and a variety of data D. The printer 9 advances a printing process by controlling operations of the transport mechanism 91, the coating processing unit 92, the print processing unit 93, and the dry processing unit 94, which are described above, and each component of the ink supplier 40 described later in accordance with the computer programs P. The printer 9 also advances a maintenance process by controlling the ink supplier 40, a maintenance unit 70, and a movement mechanism 80 in accordance with the computer programs P.

### 2. CONFIGURATION OF INK SUPPLIER

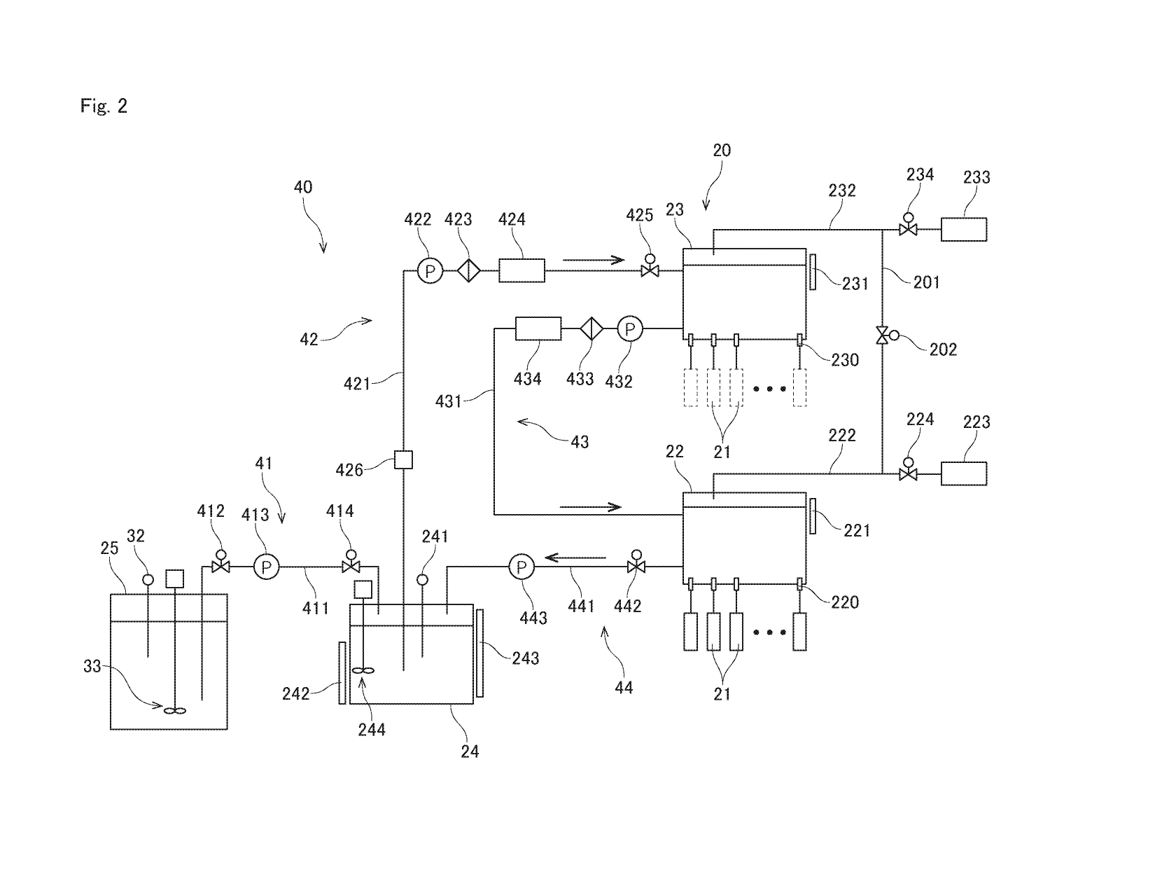

Next, a configuration of the ink supplier 40 for supplying ink to the heads 21 of the head units 20 is described with reference to FIG. 2. FIG. 2 is a schematic view showing the configuration of the ink supplier 40.

As shown in FIG. 2, each head unit 20 includes a plurality of heads 21 aligned in a horizontal direction (the direction orthogonal to the plane of the drawing in FIG. 1). In FIG. 2, a plurality of heads 21 connected to a recovery reservoir 23, indicated by broken lines, are the same as a plurality of heads 21 connected to a supply reservoir 22, indicated by solid lines. Due to the layout of the drawing, the same heads are illustrated redundantly at multiple locations.

The ink supplier 40 is an ink supply unit that supplies ink from the ink tank 25 to the heads 21. The ink supplier 40 includes, as ink storages, the supply reservoir 22 and the recovery reservoir 23 of each head unit 20, and a buffer tank 24. The ink supplier 40 includes the ink tank 25 serving as a supply source of the ink. The ink supplier 40 further includes a first transporter 41, a second transporter 42, a third transporter 43, and a fourth transporter 44 as means for ink transport between each storage.

Each head unit 20 includes the heads 21, the supply reservoir 22, and the recovery reservoir 23. Each head 21 has a plurality of ejection nozzles formed in the bottom surface, each ejection nozzle ejecting ink toward the printing medium M.

The supply reservoir 22 is an ink storage that stores the ink to be supplied to the heads 21. The supply reservoir 22 includes a level sensor 221. A detection signal from the level sensor 221 allows the controller 90 to determine the amount of the ink stored in the supply reservoir 22. Note that the level sensor 221 may be a float-type level sensor, or may be any other type of level sensor. The supply reservoir 22 further has a plurality of supply ports 220 formed in the bottom, the supply ports being respectively connected to the heads 21 in communication with each other.

The amount of the ink stored in the supply reservoir 22 is controlled so that a gas layer with a given thickness or more is formed in the upper portion of the supply reservoir 22. The gas layer formed in the supply reservoir 22 is connected to a supply pressure regulator 223 via supply pressure piping 222. Accordingly, the pressure in the supply reservoir 22 is kept at a predetermined negative pressure for the supply reservoir during the printing process. Note that the supply pressure regulator 223 may be configured by, for example, an air tank that communicates with the gas layer formed in the supply reservoir 22, a vacuum pump for exhausting gas in the air tank to atmosphere, and a pneumatic sensor for measuring the magnitude of the negative pressure developed by the vacuum pump.

The recovery reservoir 23 is an ink storage that stores the ink recovered from the heads 21. The recovery reservoir 23 includes a level sensor 231. A detection signal from the level sensor 231 allows the controller 90 to determine the amount of the ink stored in the recovery reservoir 23. Note that the level sensor 231 may be a float-type level sensor, or may be any other type of level sensor. The recovery reservoir 23 further has a plurality of recovery ports 230 formed in the bottom, the recovery ports being respectively connected to the heads 21 in communication with each other.

The amount of the ink stored in the recovery reservoir 23 is controlled so that a gas layer with a given thickness or more is formed in the upper portion of the recovery reservoir 23. The gas layer formed in the recovery reservoir 23 is connected to a recovery pressure regulator 233 via recovery pressure piping 232. Accordingly, the pressure in the recovery reservoir 23 is kept at a predetermined negative pressure for the recovery reservoir during the printing process. The negative pressure for the recovery reservoir is lower than the negative pressure for the supply reservoir. That is, the difference between atmospheric pressure and the negative pressure for the recovery reservoir is greater than the difference between atmospheric pressure and the negative pressure for the supply reservoir. Note that the recovery pressure regulator 233 may be configured by, for example, an air tank that communicates with the gas layer formed in the recovery reservoir 23, a vacuum pump for exhausting gas in the air tank to atmosphere, and a pneumatic sensor for measuring the magnitude of the negative pressure developed by the vacuum pump.

The supply pressure piping 222 includes a first on-off valve 224 interpolated therein. The recovery pressure piping 232 includes a second on-off valve 234 interpolated therein. Then, connection piping 202 connects a point of the supply pressure piping 222 on the side closer to the supply reservoir 22 than the first on-off valve 224 and a point of the recovery pressure piping 232 on the side closer to the recovery reservoir 23 than the second on-off valve 234 in communication with each other. The connection piping 201 includes a connection on-off valve 202 interpolated therein.

The buffer tank 24 stores ink temporarily. The amount of the ink stored in the buffer tank 24 is smaller than the amount of the ink stored in the ink tank 25 and greater than the amounts of the ink stored in the supply reservoir 22 and the recovery reservoir 23. The buffer tank 24 includes a temperature sensor 241, a heater 242, a level sensor 243, and a stirrer unit 244.

The temperature sensor 241 detects the temperature of the ink stored in the buffer tank 24. The heater 242 is mounted on the outer wall of the buffer tank 24. The heater 242 heats the ink stored in the buffer tank 24. The controller 90 controls the heater 242 based on the temperature of the ink detected by the temperature sensor 241.

The level sensor 243 detects the level of the ink stored in the buffer tank 24 and outputs the result of detection to the controller 90. The stirrer unit 244 stirs the ink stored in the buffer tank 24 to prevent uneven heating and uneven concentration.

The ink tank 25 is an ink storage having a maximum ink storage capacity. As the ink tank 25, for example, tanked ink purchased from an ink maker may be used as-is. The ink tank 25 is arranged in an area away from the head units 20 and the buffer tank 24.

The first transporter 41 transports the ink from the ink tank 25 to the buffer tank 24. The first transporter 41 includes piping 411, a valve 412 interpolated in the piping 411, an ink refill pump 413, and a valve 414. One end of the piping 411 is arranged in an ink storage area inside the ink tank 25. The other end of the piping 411 communicates with the interior of the buffer tank 24. When the controller 90 opens the valves 412 and 414 and operates the ink refill pump 413, the ink stored in the ink tank 25 is sent via the piping 41 to the buffer tank 24.

The second transporter 42 transports the ink from the buffer tank 24 to the recovery reservoir 23. The second transporter 42 includes piping 421, a pump 422 interpolated in the piping 421, a filter 423, a degasifier unit 424, and a valve 425. One end of the piping 421 is arranged in an ink storage area inside the buffer tank 24. The other end of the piping 421 communicates with an interior of the recovery reservoir 23. The filter 423 removes solid components (agglomerates or precipitates) contained in the ink. The degasifier unit 424 removes air bubbles contained in the ink and some gas constituents dissolved in the ink. When the controller 90 opens the valve 425 and operates the pump 422, the ink stored in the buffer tank 24 is sent via the piping 421 to the recovery reservoir 23. The piping 421 further includes a flow sensor 426 that detects the amount of the ink flowing through the piping 421.

The third transporter 43 transports the ink from the recovery reservoir 23 to the supply reservoir 22. The third transporter 43 includes piping 431, a pump 432 interpolated in the piping 431, a filter 433, and a degasifier unit 434. One end of the piping 431 is arranged in an ink storage area inside the recovery reservoir 23. The other end of the piping 431 communicates with the interior of the supply reservoir 22. The filter 433 removes solid components (agglomerates or precipitates) contained in the ink. The degasifier unit 434 removes air bubbles contained in the ink and some gas constituents dissolved in the ink. When the controller 90 operates the pump 432, the ink stored in the recovery reservoir 23 is sent via the piping 431 to the supply reservoir 22.

The fourth transporter 44 transports the ink from the supply reservoir 22 to the buffer tank 24. The fourth transporter 44 includes piping 441, and a valve 442 and a pump 443 that are interpolated in the piping 441. One end of the piping 441 is arranged in an ink storage area inside the supply reservoir 22. The other end of the piping 441 communicates with the interior of the buffer tank 24. When the controller 90 operates the pump 443, the ink stored in the supply reservoir 22 is sent via the piping 441 to the buffer tank 24.

The controller 90 controls the amounts of the ink in the first, second, third, and fourth transporters 41, 42, 43, and 44.

With this configuration, the supply reservoir 22, the heads 21, the recovery reservoir 23, and the third transporter 43 form a first ink circulation passage. As described above, the negative pressure for the recovery reservoir is lower than the negative pressure for the supply reservoir. That is, the pressure in the recovery reservoir 23 is lower than the pressure in the supply reservoir 22. Thus, in each of the heads 21, a flow of the ink is generated from the joint with the supply reservoir 22 to the joint with the recovery reservoir 23.

The buffer tank 24, the second transporter 42, the recovery reservoir 23, the third transporter 43, the supply reservoir 22, and the fourth transporter 44 form a second ink circulation passage. When the ink is transported by the second, third, and fourth transporters 42, 43, and 44 at the same time, a flow of the ink is generated from the buffer tank 24 through the second transporter 42, the recovery reservoir 23, the third transporter 43, the supply reservoir 22, and the fourth transporter 44 to the buffer tank 24.

During the printing process and even during a standby process after printing is stopped, the controller 90 continues to circulate the ink in the first and second ink circulation passages. On the other hand, during at least a later-described wiping process in the maintenance process, the controller 90 stops the circulation of the ink in the first and second ink circulation passages.

When the ink is ejected from the heads 21 and the amount of the ink stored in the supply reservoir 22 decreases during the printing process or the maintenance process, the liquid level of the ink drops in the supply reservoir 22. In this case, a detection signal from the level sensor 221 allows the controller 90 to recognize the drop in the liquid level in the supply reservoir 22. Then, the controller 90 causes the second and third transporters 42 and 43 to start the transport of the ink so as to make the liquid levels detected by the level sensor 221 and the level sensor 231 fall within a predetermined range. In the case where the ink has already being transported in the first or second ink circulation passage, the controller 90 increases the amount of the ink transported by the second and third transporters 42 and 43.

When the amount of the ink stored in the buffer tank 24 has decreased as a result of ink supply from the buffer tank 24 to the head units 20, the liquid level of the ink drops in the buffer tank 24. In this case, a detection signal from the level sensor 243 allows the controller 90 to recognize the drop in the liquid level in the buffer tank 24. Then, the controller 90 causes the first transporter 41 to transport the ink so as to make the liquid level detected by the level sensor 243 fall within a predetermined range.

### 3. CONFIGURATION OF HEAD UNIT

Following description is given regarding a detailed configuration of the head units 20. The heads units 20 of the color printer 931 and the head unit 20 of the white printer 932 have the same structure.

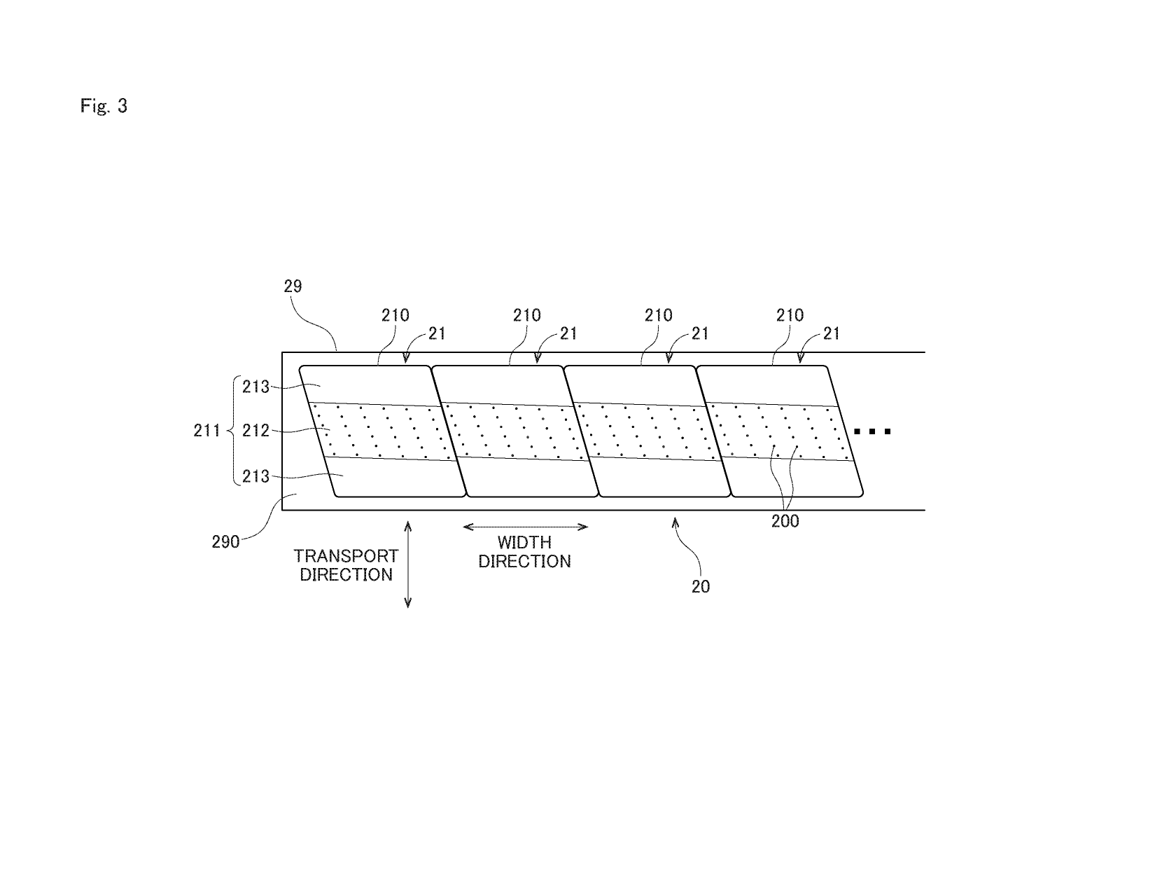

In the following description, the direction along the transport path for the printing medium M is referred to as a “transport direction”, and the direction along the short sides of the printing medium M is referred to as a “width direction”. FIG. 3 is a bottom view of one head unit 20.

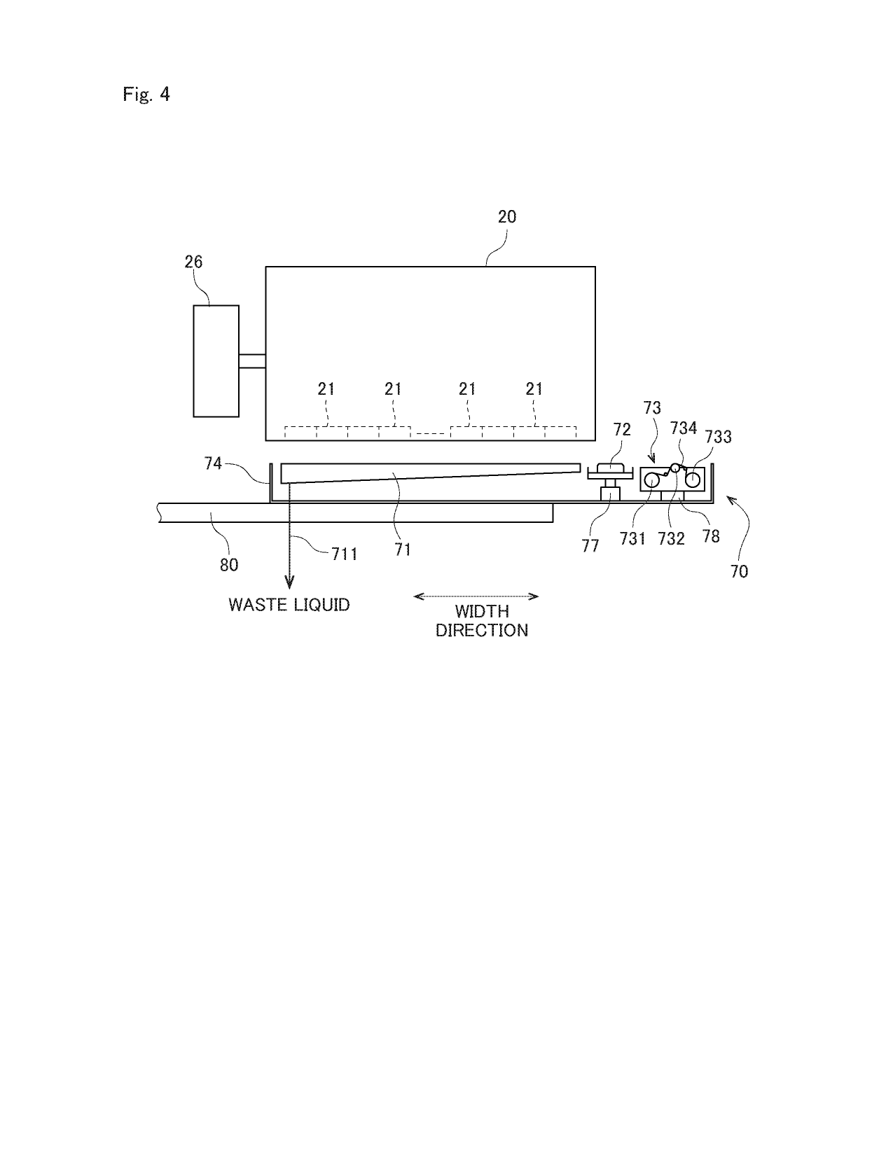

As shown in FIG. 3, the head unit 20 includes a head unit body 29 (see FIG. 4) and a plurality of heads 21 mounted on the lower surface of the head unit body 29, the heads 21 ejecting one color of ink. The heads 21 are aligned in the width direction. Each head 21 includes a box-like casing 210. In the example shown in FIG. 3, the lower surface of the casing 210 has an approximately parallelogram shape. Alternatively, the lower surface of the casing 21 may have a rectangular shape. Moreover, the lower surface of the head unit body 29, i.e., a peripheral surface 290, is located around the outer periphery of each casing 210.

As shown in FIG. 3, each head 21 has a lower surface 211 that includes a nozzle surface 212 and a pair of side surfaces 213. The nozzle surface 212 and the pair of side surfaces 213 are aligned in the transport direction. The nozzle surface 212 is located between the pair of side surfaces 213.

The nozzle surface 212 has a plurality of nozzles 200 capable of ejecting ink. The nozzles 200 are aligned in the width direction. In the example shown in FIG. 3, the nozzles 200 are aligned in the width direction at different positions in the transport direction. Such a two-dimensional arrangement of the nozzles 200 makes the positions of the nozzles 200 in the width direction close to one another. Alternatively, the nozzles 200 may be aligned in a single row in the width direction. Each nozzle 200 has an ink ejection port that is open downward.

The nozzles 200 eject ink droplets in accordance with a command received from the controller 90. As the method of ejecting ink from the nozzles 200, for example, a so-called piezoelectric method is employed in which the ink in the nozzles 200 is ejected under pressure by applying a voltage so as to deform piezoelectric elements. Alternatively, the ink ejection method may be a so-called thermal method in which the ink in the nozzles 200 is ejected by energizing a heater to heat and expand the ink.

The pair of side surfaces 213 is provided on both sides of the nozzle surface 212 in the transport direction. Each side surface 213 is adjacent to one side of the nozzle surface 212 in the transport direction.

### 4. MAINTENANCE PROCESS FOR HEAT UNIT

Next description is given regarding the maintenance process and a configuration for performing the maintenance of the head units 20 described above. The printer 9 includes, for each head unit 20, the maintenance unit 70 and the movement mechanism 80. FIG. 4 is a diagram showing configurations of one head unit 20, the maintenance unit 70, and the movement mechanism 80.

The head unit 20 is arranged at a printing position corresponding to the printing surface of the printing medium M. The maintenance unit 70 performs maintenance such as cleaning on the head unit 20 arranged at the printing position.

As shown in FIG. 4, the maintenance unit 70 includes a cap 71, a cleaning block 72, a wiping unit 73, and a base frame 74. The cap 71, the cleaning block 72, and the wiping unit 73 are aligned in order from the downstream side to the upstream side in the width direction. The cap 71, the cleaning block 72, and the wiping unit 73 are also supported by the base frame 74.

The cap 71 is a portion that covers the lower surfaces 211 of the heads 21. The cap 71 has a bottom and side walls, and has an open top. The cap 71 collectively covers the lower surfaces 211 of the heads 21 of one head unit 20. When a purging operation is performed, the cap 71 receives the ink ejected from the heads 21. The cap 71 has a drainage tube 711 in the bottom. The ink ejected from the heads 21 is discharged from the cap 71 to the drainage tube 711.

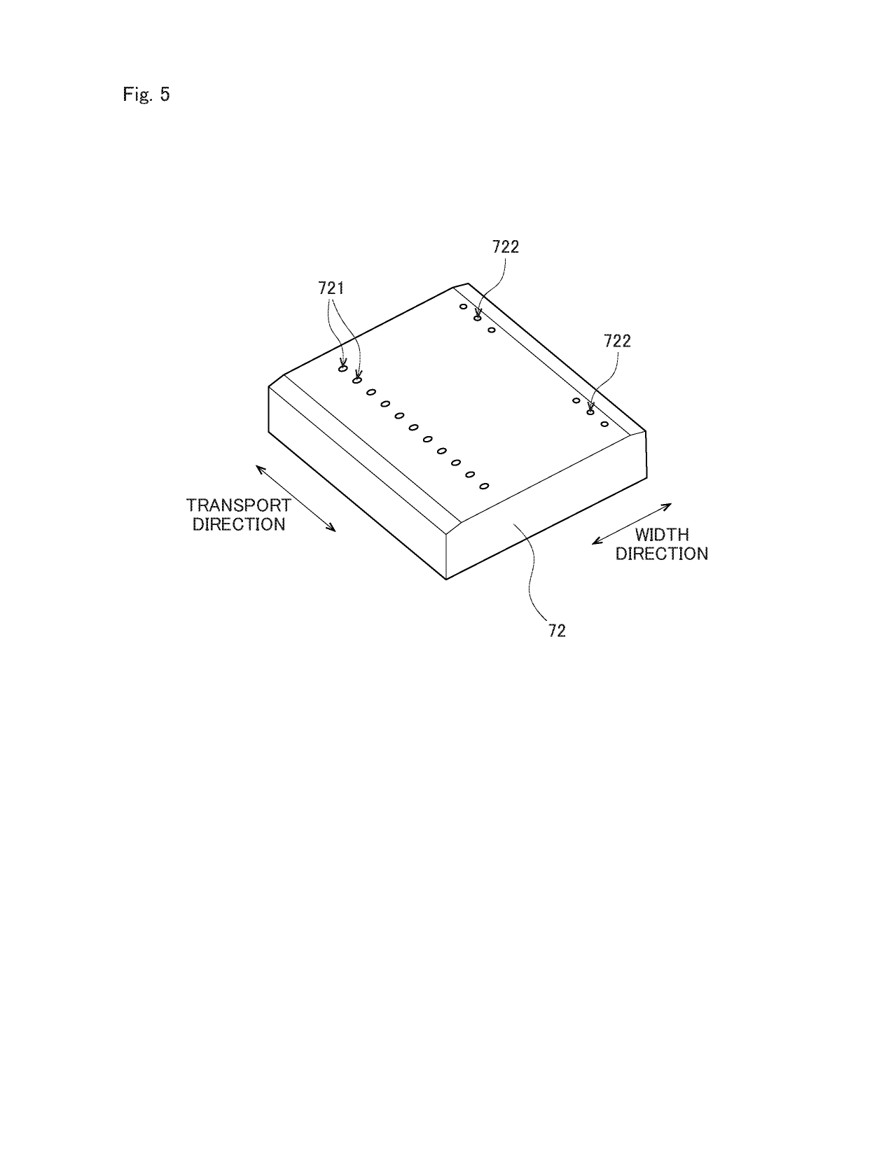

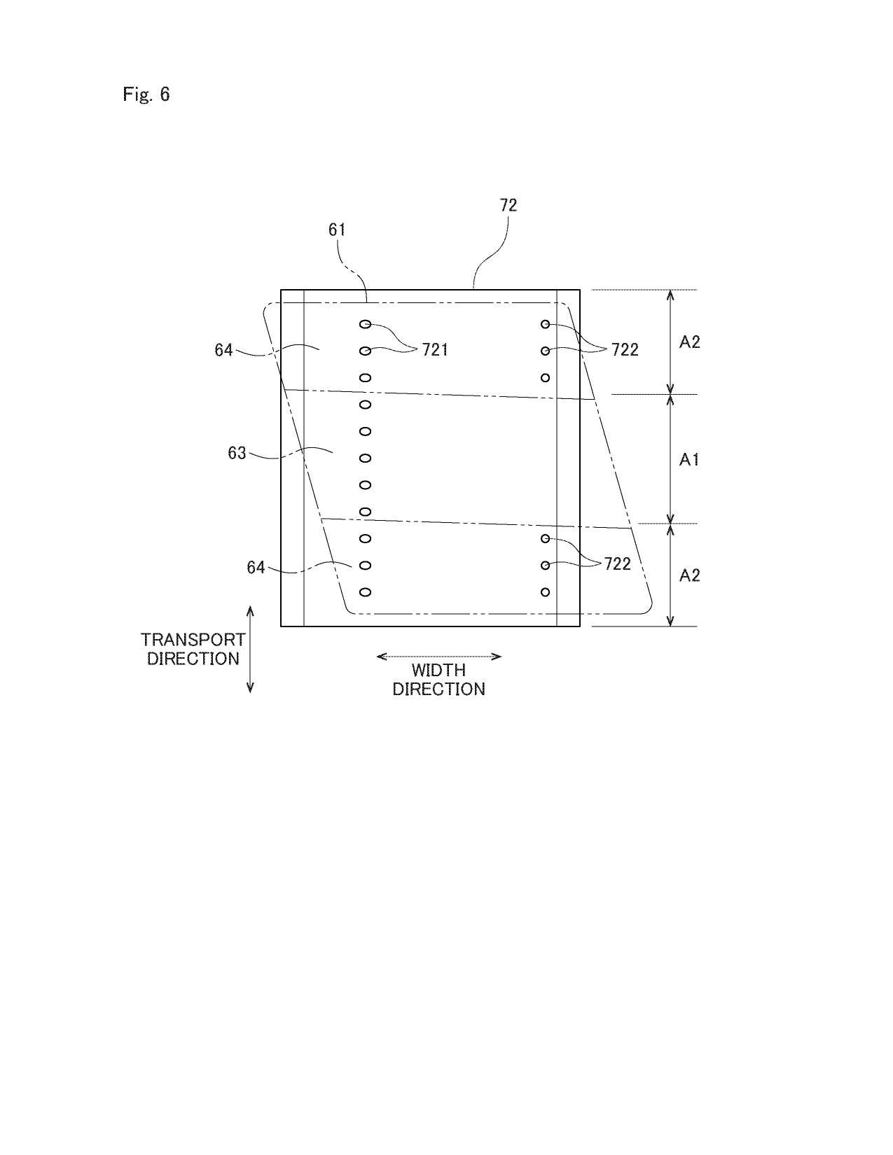

The cleaning block 72 is a unit that cleans the lower surfaces 211 of the heads 21 with the ink adhering thereto. The cleaning block 72 is located between the cap 71 and the wiping unit 73 in the width direction. The cleaning block 72 has an upper surface that is parallel to the lower surfaces 211 of the heads 21. FIG. 5 is a top perspective view of the cleaning block 72. FIG. 6 is a top view of the cleaning block 72. As shown in FIGS. 5 and 6, the cleaning block 72 has an upper surface provided with a plurality of supplying holes 721 and a plurality of suction holes 722.

The supplying holes 721 are holes for supplying a cleaning liquid toward the lower surfaces 21 of the heads 21. The supplying holes 721 are aligned in the transport direction in the upper surface of the cleaning block 72. The suction holes 722 are holes for sucking in the ink from the lower surfaces 211 of the heads 21. The suction holes 722 are aligned in the transport direction at positions away from the supplying holes 721 in the width direction in the upper surface of the cleaning block 72.

When the cleaning block 72 performs cleaning of the ink, the cleaning liquid supplied from a cleaning-liquid supplier, which is not shown, is ejected through the supplying holes 721. The cleaning liquid may, for example, be a solvent that excludes colored components of the ink. The suction holes 722 are connected to a negative-pressure developer, which is not shown. The negative-pressure developer may, for example, be an ejector or a pump. When a negative pressure is developed by the negative-pressure developer, the ink and the cleaning liquid that adhere to the lower surfaces 211 of the heads 21 are sucked in through the suction holes 722 and stored in a waste liquid storage, which is not shown.

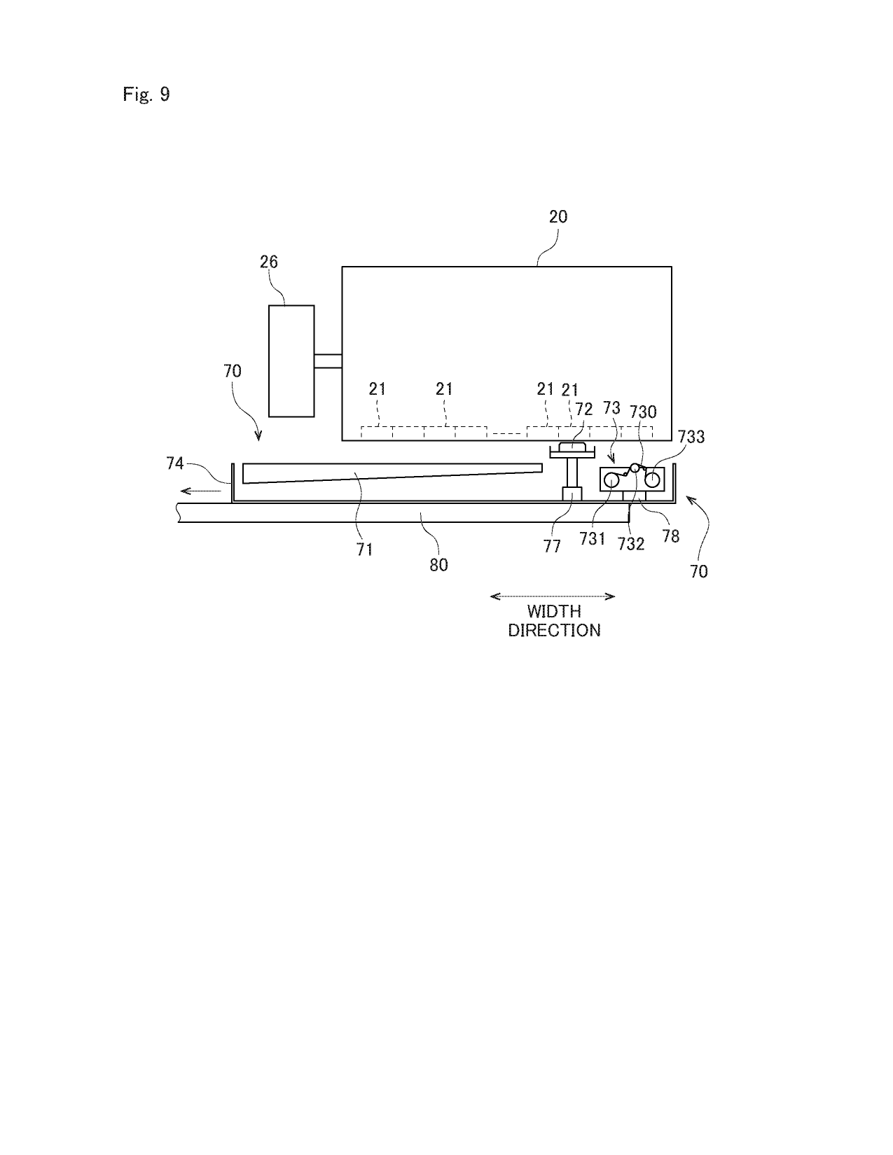

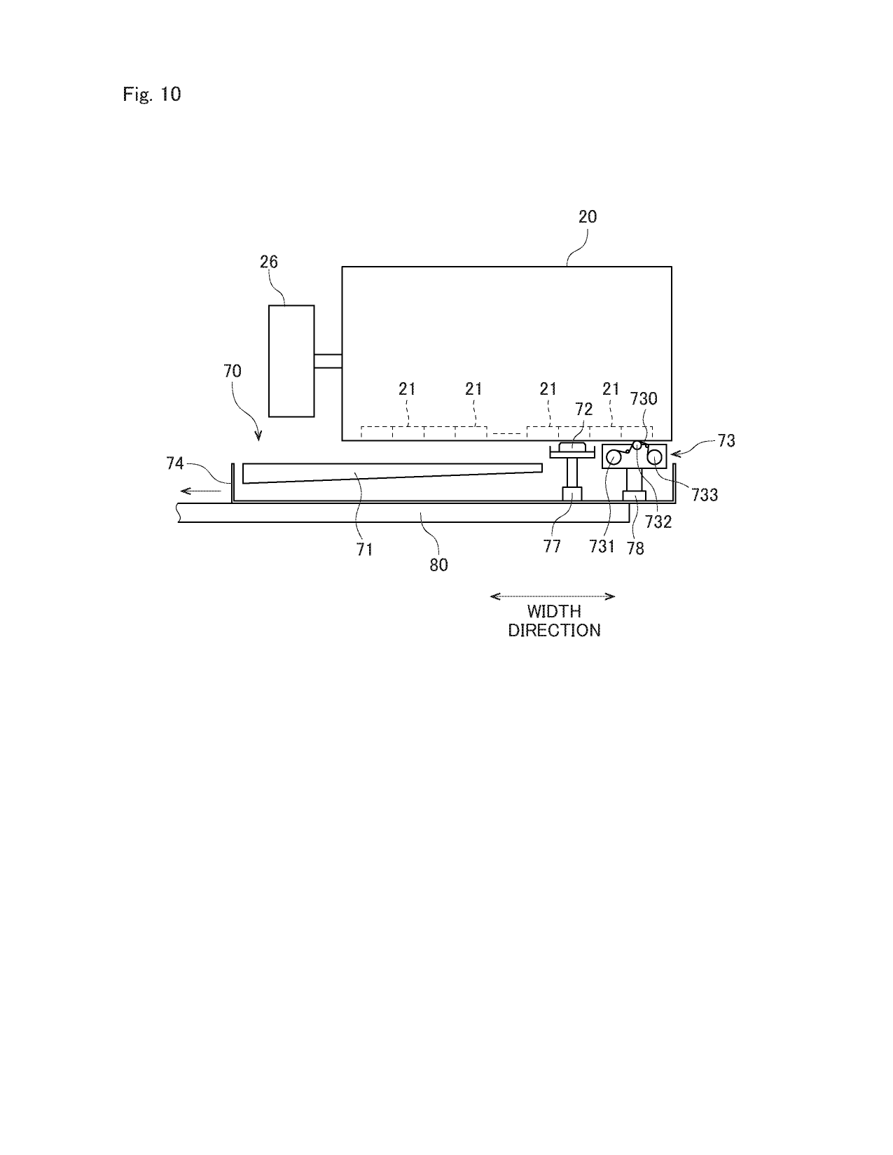

The maintenance unit 70 further includes a first elevating mechanism 77 as shown in FIG. 4. The first elevating mechanism 77 raises or lowers the cleaning block 72 with respect to the base frame 74 of the maintenance unit 70. Specifically, the first elevating mechanism 77 raises and lowers the cleaning block 72 between a first upper position and a first lower position, the first upper position being a position at which the cleaning block 72 is in close proximity to the lower surfaces 211 of the heads 21, the first lower position being a position lower than the first upper position. The cleaning block 72 shown in FIG. 4 is arranged in the first lower position, and the cleaning block 72 shown in FIGS. 9 and 10 is arranged in the first upper position. The first elevating mechanism 77 may, for example, be an air cylinder or the like.

FIG. 6 shows, by virtual lines (chain double-dashed lines), the position of one head 21 during cleaning performed by the cleaning block 72. As shown in FIG. 6, the upper surface of the cleaning block 72 includes a first area A1 and a pair of second areas A2. The first area A1 is an area that faces the nozzle surface 212 of the head 21 in the up-down direction during cleaning of the head 21 by the cleaning block 72. The second areas A2 are areas that face the side surfaces 213 of the head 21 in the up-down direction during cleaning of the head 21 by the cleaning block 72.

The supplying holes 721 are provided in the first area A1 and the pair of second areas A2. That is, the supplying holes 721 are provided at fixed intervals in the range from one of the second areas A2 through the first area A1 to the other second area A2. Thus, the cleaning liquid ejected from the supplying holes 721 is supplied to the nozzle surface 212 and the pair of side surfaces 213 of the head 21. Accordingly, the nozzle surface 212 and the pair of side surfaces 213 are each cleaned with the cleaning liquid.

Meanwhile, the suction holes 722 are provided in only the pair of second areas A2 among the first area A1 and the pair of second areas A2. That is, the suction holes 722 are not provided in the first area A1. This makes the suction force in the first area A1 smaller than the suction force in the second area A2. Accordingly, the suction force acting on the nozzle surface 212 of the head 21 can be made smaller than the suction force acting on the side surfaces 213.

Inside the nozzles 200 provided in the nozzle surface 212, an air-water interface of the ink forms a meniscus. If the ink is sucked out from the inside of the nozzles 200, this meniscus may be destructed, resulting in ejection failures. However, if the suction force acting on the nozzle surface 212 is made smaller than the suction force acting on the side surfaces 213 as described above, the ink is prevented from being sucked out from the inside of the nozzles 200. Accordingly, it is possible to avoid failures of ink ejection from the nozzles 200.

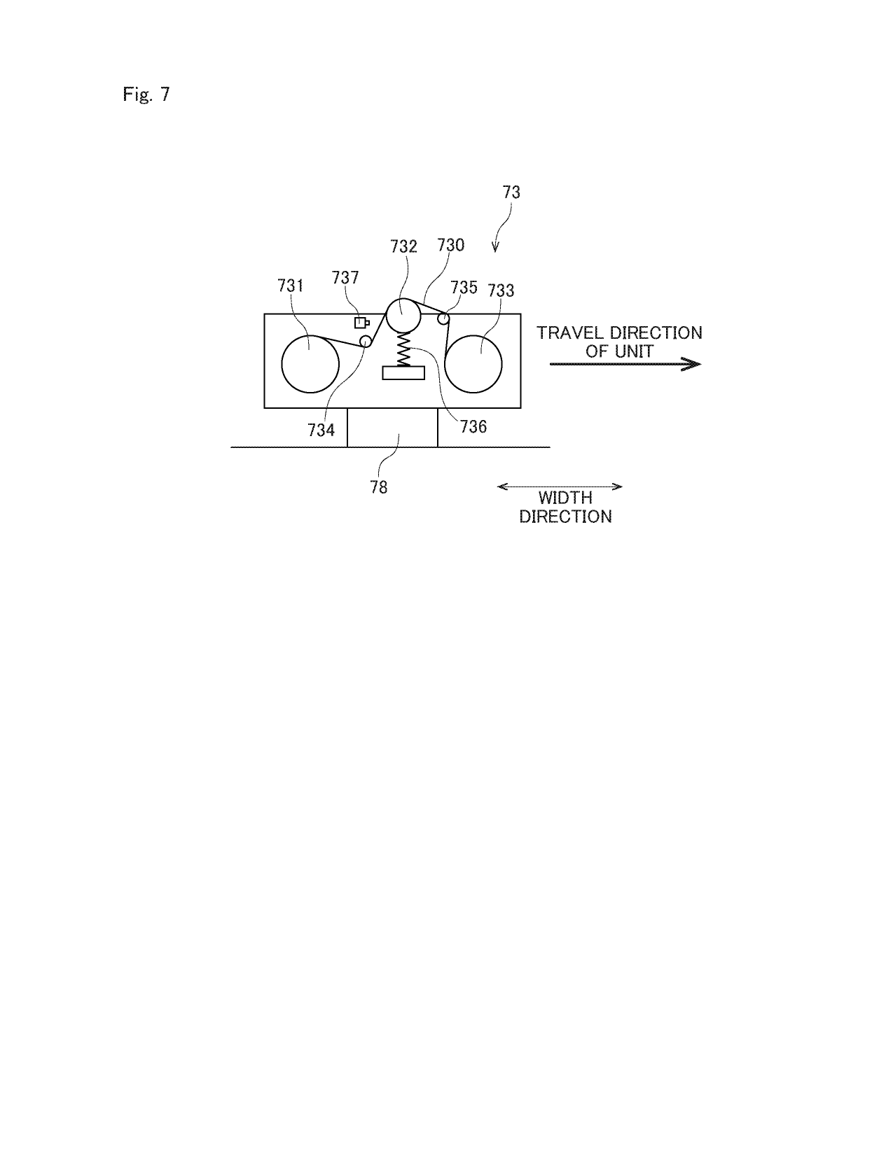

The wiping unit 73 is a mechanism for wiping the ink and the cleaning liquid adhering to the lower surfaces 211 of the heads 21 with a strip sheet 730. That is, the sheet 730 serves as a wiper that wipes off the lower surfaces 211 of the heads 21. FIG. 7 is a diagram showing a configuration of the wiping unit 73. As shown in FIG. 7, the wiping unit 73 includes a feed roller 731, a wiping roller 732, a recovery roller 733, a first auxiliary roller 734, and a second auxiliary roller 735.

The feed roller 731 and the recovery roller 733 are arranged at an interval in the width direction. The wiping roller 732 is arranged between the feed roller 731 and the recovery roller 733. The wiping roller 732 is arranged above the feed roller 731 and the recovery roller 733. The wiping roller 732 is biased upward by an elastic spring 736. The first auxiliary roller 734 is arranged between the feed roller 731 and the wiping roller 732. The second auxiliary roller 735 is arranged between the wiping roller 732 and the recovery roller 733.

The strip sheet 730 unreeled from the top of the feed roller 731 passes through the underside of the first auxiliary roller 734, the upper side of the wiping roller 732, the upper side of the second auxiliary roller 735, and the underside of the recovery roller 733 and is taken up by the recovery roller 744. The material for the sheet 730 may, for example, be a cloth or paper.

The wiping unit 73 further includes a cleaning-liquid ejection nozzle 737. The cleaning-liquid ejection nozzle 737 ejects the cleaning liquid to the sheet 730 at a position between the first auxiliary roller 734 and the wiping roller 732. Accordingly, the sheet 730 is wet with the cleaning liquid. In this way, wetting the sheet 730 with the cleaning liquid reduces the frictional force acting between the sheet 730 and the lower surfaces 211 of the heads 21. This prevents the lower surfaces 211 of the heads 21 from being worn out by the friction with the sheet 730. The cleaning liquid ejected from the cleaning-liquid ejection nozzle 737 may be the same as the cleaning liquid ejected from the the cleaning block 72. That is, the cleaning liquid may, for example, be a solvent that excludes colored components of the ink.

The wiping unit 73 brings the sheet 730 supported on the wiping roller 732 into contact with the lower surfaces 211 of the heads 21. Then, with the sheet 730 sandwiched between the wiping roller 732 and the lower surface 211, the sheet 730 is transported from the feed roller 731 to the recovery roller 733. Accordingly, the sheet 730 wipes the ink and the cleaning liquid off the lower surfaces 211. In a later-described wiping process (step S203), the wiping unit 73 travels relative to the head unit 20 in the direction of the arrow indicated as “Unit Travel Direction” in FIG. 7.

The maintenance unit 70 further includes a second elevating mechanism 78. The second elevating mechanism 78 raises and lowers the wiping unit 73 with respect to the base frame 74 of the maintenance unit 70. Specifically, the second elevating mechanism 78 raises and lowers the wiping unit 73 between a second upper position and a second lower position, the second upper position being a position at which the wiping roller 732 comes in contact with the nozzle surface 212 and the side surfaces 213 of the head 21, the second lower position being lower than the second upper position. The second elevating mechanism 78 may, for example, be an air cylinder or the like. The wiping unit 73 shown in FIGS. 4 and 9 is arranged at the second lower position, and the wiping unit 73 shown in FIG. 10 is arranged at the second upper position.

As shown in FIG. 4, the movement mechanism 80 is a mechanism for moving the maintenance unit 70 in the width direction. The movement mechanism 80 moves the maintenance unit 70 in the width direction with respect to the head unit 20 arranged at a maintenance position. The movement mechanism 80 may, for example, be a direct-acting mechanism using a ball screw. Alternatively, the movement mechanism 80 may also be a direct-acting mechanism configured by other mechanisms such as a linear motor.

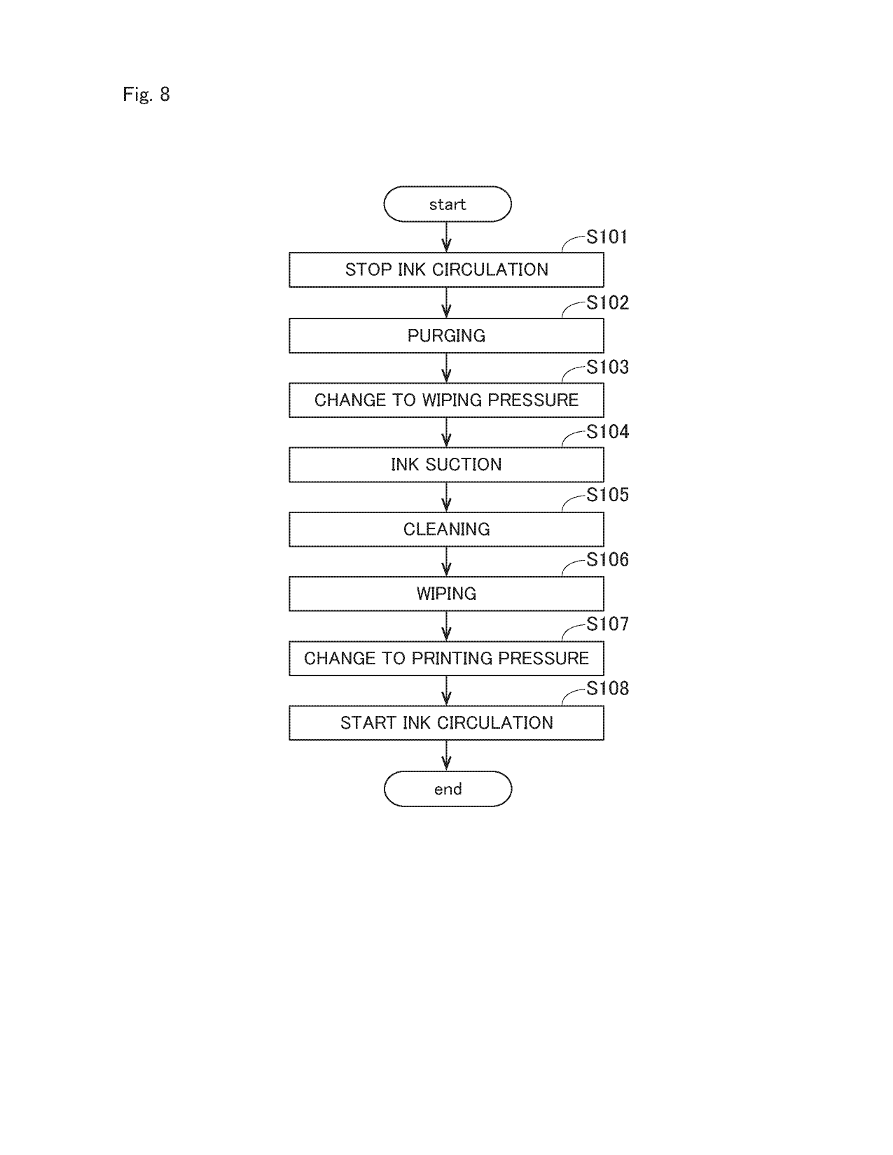

Following description is given regarding operations of performing the maintenance of the head unit 20 by using the maintenance unit 70 described above. FIG. 8 is a flowchart showing a procedure of the maintenance process performed on the head unit 20. The following procedure proceeds when the controller 9 controls the operations of each component in accordance with a computer program P.

The maintenance of the head unit 20 is mainly implemented by two types of methods. The two types include ordinary maintenance performed at regular time intervals and maintenance with purging performed in a medium or long term. The maintenance process in FIG. 8 shows maintenance with purging. The ordinary maintenance is processing that corresponds to steps S101, S103, and S105 to S108, excluding steps S102 and S104, from among the total maintenance process including steps S101 to S108.

When the maintenance with purging is performed on the head unit 20, firstly, the circulation of the ink is stopped (step S101). That is, the controller 90 stops the circulation of the ink in the first and second ink circulation passages.

Specifically, the controller 90 regulates the negative pressure for the supply reservoir, which is output from the supply pressure regulator 223, and the negative pressure for the recovery reservoir, which is output from the recovery pressure regulator 233, with reference to output values of the pneumatic sensor of the supply pressure regulator 223 and the pneumatic sensor of the recovery pressure regulator 233 so that both of the negative pressure for the supply reservoir and the negative pressure for the recovery reservoir become an average value of the previous negative pressures for the supply reservoir and the previous negative pressure for the recovery reservoir. Accordingly, the pressure in the supply reservoir 22 and the pressure in the recovery reservoir 23 are set to be the same pressure. This resolves a pressure difference between the supply reservoir 22 and the recovery reservoir 23.

Then, the controller 90 stops the pumps 422 and 443. This stops the flow of the ink from the second transporter 42 and the fourth transporter 44. The controller 90 further stops the pump 432. This stops the flow of the ink from the third transporter 43 and the flow of the ink inside the heads 21. At the time when the circulation of the ink is stopped in step S101, the first on-off valve 224 and the second on-off valve 234 are open, and the connection on-off valve 202 is closed.

Then, a purging operation is performed in the maintenance with purging (step S102). When the purging operation is to be performed, the movement mechanism 80 arranges the maintenance unit 70 at the position shown in FIG. 4. At the position shown in FIG. 4, the cap 71 of the maintenance unit 70 is placed under the head unit 20. The cleaning block 72 and the wiping unit 73 are placed at positions deviated from under the head unit. This position is referred to as a widthwise origin position of the maintenance unit 70. Then, a head elevating mechanism 26 lowers the head unit 20. Accordingly, the lower surfaces 211 of the heads 21 are covered with the cap 71. The head elevating mechanism 26 may, for example, be a direct-acting mechanism using a ball screw. Alternatively, the head elevating mechanism 26 may also be a direct-acting mechanism configured by any other mechanism such as a linear motor.

In this state, the printer 9 continuously ejects the ink from the nozzles 200 of the heads 21. That is, the controller 90 supplies the ink to each head 21 of the head units 20 while applying a pressure to the ink stored in the heads 21. Accordingly, the ink is ejected continuously from the nozzles 200 of each head 21. As a result of the purging operation, foreign materials contained in the ink or agglomerates of the ink itself are discharged from the nozzles 200. As a result, clogging of the nozzles 200 is resolved. However, when the purging operation is performed, the ink adheres to the lower surface 211 of each head 21.

After the purging operation is performed for a predetermined period of time, the controller 90 ends the application of pressure to the ink. This ends the purging operation. Then, the head elevating mechanism 26 raises the head unit 20. Accordingly, the head unit 20 is separated above from the cap 71 and returns to the state shown in FIG. 4.

Then, the printer 9 regulates the pressure in each nozzle (step S103). That is, the controller 90 changes the negative pressure for the supply reservoir, which is output from the supply pressure regulator 223, and the negative pressure for the recovery reservoir, which is output from the recovery pressure regulator 233, such that the pressure in each nozzle 200 becomes a predetermined wiping pressure P_{w}. The negative pressure for the supply reservoir and the negative pressure for the recovery reservoir at this time are calculated by back calculation from the pressures in the nozzles 200. Then, when the pressures in the nozzles 200 settle at around the predetermined wiping pressure P_{w}, the controller 90 closes the first on-off valve 224 and the second on-off valve 234. Moreover, the controller 90 opens the connection on-off valve 202.

In this present embodiment, after the circulation of the ink is stopped in step S101, the pressures in the nozzles 200 are regulated to become the wiping pressure P_{w} by regulating the pressures in the air spaces of the supply reservoir 22 and the recovery reservoir 23 without the circulation of the ink. This eliminates the influence of pulsation or the like of the pumps 422, 432 and 443, thereby allowing the pressures in the nozzles 200 to be stably adjusted to the wiping pressure P_{w}.

Then, the printer 9 sucks in the ink via the cleaning block 72 (step S104). FIG. 9 is a diagram showing an ink suction process. Specifically, the movement mechanism 80 moves the maintenance unit 70 downstream in the width direction so as to locate the upper surface of the cleaning block 72 immediately under the peripheral surface 290 of the head unit body 29. Then, the first elevating mechanism 77 moves the cleaning block 72 from the first lower position to the first upper position. The controller 90 further controls the head elevating mechanism 26 to lower the head unit 20 and to bring the upper surface of the cleaning block 72 into close proximity to immediately under the peripheral surface 290 that is adjacent on the upstream side in the width direction to the head 21 that is located on the most upstream side in the width direction. Thereafter, the controller 90 starts to suck in the ink through the suction holes 722.

In this state, the movement mechanism 80 moves the maintenance unit 70 to the downstream side in the width direction. The direction of travel of the maintenance unit 70 is the direction from the wiping unit 73 to the cap 71. The cleaning block 72 moves in the width direction along the lower surfaces 211 of the heads 21 while sucking in the ink through the suction holes 722. This removes the ink adhering to the lower surfaces 211 of the heads 21.

Thereafter, the controller 90 causes the first elevating mechanism 77 to move the cleaning block 72 from the first upper position to the first lower position . Then, the controller 90 causes the head elevating mechanism 26 to raise the head unit 20. Then, the movement mechanism 80 moves the maintenance unit 70 to the upstream side in the width direction and places the maintenance unit 70 again at the widthwise origin position shown in FIG. 4.

Thereafter, the controller 90 performs a cleaning process (step S105) and a wiping process (step S106). For each area of the lower surfaces 211 of the heads 21, the wiping process (step S106) is performed after the cleaning process (S105), but when viewed from the heads 21 as a whole, the cleaning process (step S105) and the wiping process (step S106) progress at the same time.

Specifically, the controller 90 controls the movement mechanism 80 to move the maintenance unit 70 in the width direction so that the upper surfaces of the cleaning block 72 and the wiping unit 73 are located immediately under the peripheral surface 290 which is adjacent on the upstream side in the width direction to the head 21 that is located on the most upstream side in the width direction. Then, the first elevating mechanism 77 moves the cleaning block 72 from the first lower position to the first upper position, and the second elevating mechanism 78 moves the wiping unit 73 from the second lower position to the second upper position. The controller 90 further controls the head elevating mechanism 26 to lower the head unit 20 and bring the peripheral surface 290 into contact with the sheet 730 of the wiping unit 73. In this way, in the present embodiment, the head unit 20 and the maintenance unit 70 are in close proximity to each other in both upward and downward directions. This reduces the impact of the wiping unit 73 when coming into contact with the lower surface of the head unit 20.

Then, the controller 90 causes the cleaning block 72 to start the ejection of the cleaning liquid through the supplying holes 721 and the suction of the ink through the suction holes 722 (step S105). The controller 90 also starts the wiping off of the lower surfaces 211 of the heads 21 by starting the transport of the sheet 730 from the feed roller 731 to the recovery roller 733 and ejecting the cleaning liquid from the cleaning-liquid ejection nozzle 737 to the sheet 730 (step S106).

In this state, the movement mechanism 80 moves the maintenance unit 70 from the upstream side to the downstream side in the width direction. The direction of travel of the maintenance unit 70 is the direction from the wiping unit 73 to the cap 71. Accordingly, the cleaning block 72 moves in the width direction along the lower surfaces 211 of the heads 21 while ejecting the cleaning liquid through the supplying holes 721 and sucking in the ink through the suction holes 722.

The cleaning liquid ejected through the supplying holes 721 is supplied to the nozzle surface 212 and the side surfaces 213 of each head 21. Then, the ink and the cleaning liquid adhering to the nozzle surface 212 and the side surfaces 213 are sucked in through the suction holes 722. This cleans the nozzle surface 212 and the pair of side surfaces 213 and removes the ink from the nozzle surface 212 and the side surfaces 213. Thus, the nozzle surface 212 and the side surfaces 213 have no ink adhering thereto. Along with the movement of the cleaning block 72, the nozzle surfaces 212 and the side surfaces 213 of all of the heads 21 are cleaned, and the ink is removed from the nozzle surfaces 212 and the side surfaces 213 of all of the heads 21. Thus, the ink does not adhere to the nozzle surfaces 212 and the side surfaces 213 of all of the heads 21.

The cleaning process (step S105) is executed while the upper surface of the cleaning block 72 is not in contact with the nozzle surface 212 and the side surfaces 213 of each head 21. This prevents the upper surface of the cleaning block 72 from producing friction with and wearing out the nozzle surface 212 and the side surfaces 213 of each head 21.

Along with the movement of the maintenance unit 70, the cleaning by the cleaning block 72 is followed by wiping by the wiping unit 73. The wiping unit 73 transports the sheet 730 supported on the wiping roller 732 from the feed roller 731 to the recovery roller 733 while being in contact with the lower surfaces 211 of the heads 21. Accordingly, the ink and the cleaning liquid remaining on the lower surfaces 211 of the heads 21 are wiped off with the sheet 730. At this time, the sheet 730 is biased upward by the elastic spring 736 via the wiping roller 732. Thus, the sheet 730 is favorably in intimate contact with the lower surface 211 of each head 21 including the nozzle surface 212.

When the cleaning process (step S105) and the wiping process (step S106) have been performed on all of the heads 21, the first elevating mechanism 77 moves the cleaning block 72 from the first upper position to the first lower position, and the second elevating mechanism 78 moves the wiping unit 73 from the second upper position to the second lower position. Then, the controller 90 controls the head elevating mechanism 26 to raise the head unit 20. Thereafter, the movement mechanism 80 moves the maintenance unit 70 to a position at which the cap 71 covers the lower surfaces 211 of all of the heads 21.

After the cleaning process (step S105) and the wiping process (step S106) are completed, the controller 90 closes the connection on-off valve 202 and opens the first on-off valve 224 and the second on-off valve 234. Then, the controller 90 changes the negative pressure for the supply reservoir, which is output from the supply pressure regulator 223, and the negative pressure for the recovery reservoir, which is output from the recovery pressure regulator 233, to the same pressure as that during the ordinary printing process. Accordingly, the pressure in each nozzle 200 becomes a printing pressure, i.e., a first pressure P₁ (step S107).

Then, the controller 90 starts the circulation of the ink in the first and second ink circulation passages (step S108). That is, the controller 90 opens the valves 425 and 442 and starts to control drive of the pumps 422, 432, and 443. This produces the flows of ink via the first, second, third, and fourth transporters 41, 42, 43, and 44.

As described above, in the maintenance with purging, the maintenance unit 70 performs a purge operation to remove clogging of the nozzles 200, and thereafter the cleaning block 72 sucks in and removes the ink adhering to the lower surfaces 211 of the heads 21. Thereafter, the nozzles 200 provided in the lower surfaces 211 of the heads 21 are maintained in a favorable state by means of the cleaning and suction of the ink by the cleaning block 72 and the wiping of the cleaning liquid by the wiping unit 73.

In the ordinary maintenance without the purge operation, only steps S101, S103, and S105 to S108 are performed from among the steps included in the aforementioned maintenance with purging. In the ordinary maintenance, the nozzles 200 provided in the lower surfaces 211 of the heads 21 can be maintained in a favorable state by means of the cleaning of the lower surfaces 211 of the heads 21 and the suction and removal of the ink by the cleaning block 72 and the wiping by the wiping unit 73 .

If the purging (step S102), the suction of the ink (step S104), the cleaning process (step S105), and the wiping process (step S106) are performed in a state in which the circulation of the ink continues, foreign materials that have existed inside the nozzles 200 since before the start of maintenance can easily intrude into the ink circulation passage (first and second ink circulation passages) together with the circulated ink. However, the present embodiment can avoid such a situation because the maintenance of the lower surfaces of the heads is performed while the circulation of the ink is stopped.

Besides, the control for setting the pressure in each nozzle to the wiping pressure P_{w} is executed (S103) after the circulation of the ink is stopped (step S101). This enables accurately regulating the pressure in each nozzle because the control for setting the pressure in each nozzle to the wiping pressure P_{w} is performed while the circulation of the ink is stopped.

In the present embodiment, the wiping process (step S106) is executed while not a dry cloth but the sheet 730 with the cleaning liquid adhering thereto is brought into contact with the lower surfaces 211 of the heads 21 including the nozzle surfaces 212. Since the wiping process (step S106) is executed with less friction, it is possible to reduce the wearing away of the nozzle surfaces 212 during wiping.

### 5. SETTING OF WIPING PRESSURE

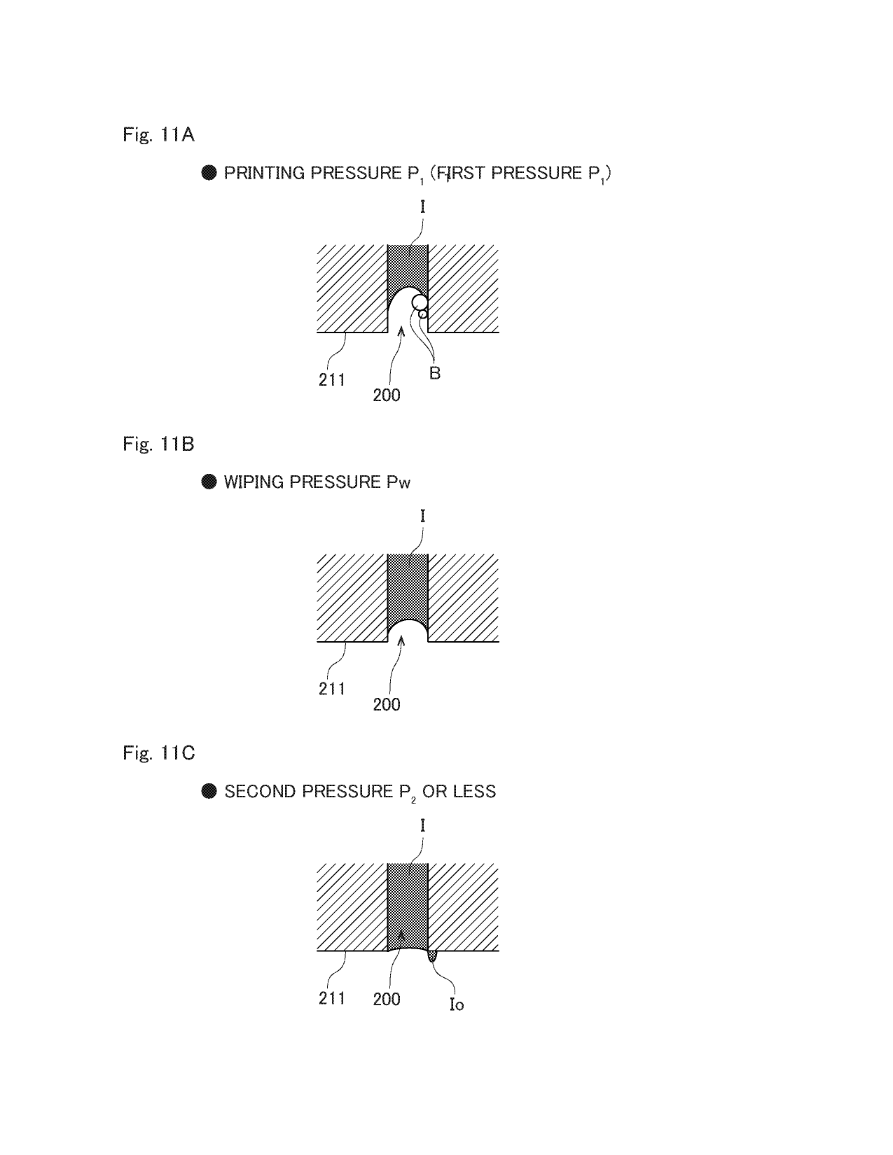

The following description is given regarding a method of setting the wiping pressure P_{w}, which is the pressure in each nozzle during execution of the cleaning process (step S105) and the wiping process (step S106) described above. FIG. 11A-11C are diagrams schematically showing the liquid level of the ink in one nozzle 200 before execution of the cleaning process (step S105). FIG. 11A shows the case where the pressure in the nozzle is the printing pressure P₁ (first pressure P₁) which is the pressure in the nozzle during the printing process and the standby process. FIG. 11B shows the case where the pressure in the nozzle is the appropriate wiping pressure P_{w}. FIG. 11C shows the case where the pressure in the nozzle is lower than or equal to a second pressure P₂ that is lower than the appropriate wiping pressure P_{w}. The second pressure P₂ is the highest pressure (lowest negative pressure) under which the ink in the nozzles 200 or on the lower surfaces 211 of the heads 21 adheres to the sheet 730 serving as the wiper in the wiping process (step S106). In FIG. 11A-11C, the ink is indicated by I.

As shown in FIG. 11A 1, in the case where the pressure in the nozzle is the printing pressure P₁ (first pressure P₁) appropriate for print processing, the cleaning liquid or bubbles B formed from the cleaning liquid may intrude into the nozzle 200 during the cleaning process (step S105) or the wiping process (step S106). The intrusion of the cleaning liquid or the bubbles B into the nozzle 200 may cause a so-called “failing nozzle” in which the ink is not ejected properly from the nozzle 200.

As shown in FIG. 11C, in the case where the pressure in the nozzle is too high (the negative pressure is too low), the ink is easily ejected from the ejection port of the nozzle 200. Thus, the liquid level of the ink may come into contact with the sheet 730 that is moving in contact with the lower surface 211 of the head 21 during the wiping process (step S106), and the ink in the nozzle 200 may adhere to the sheet 730. Besides, an ink droplet Io may come out from the inside of the nozzle 200 and adhere to the lower surface 211 as shown in FIG. 11C. Even in this case, the ink on the lower surface 211 adheres to the sheet 730 during the wiping process (step S106).

If the wiping process (step S106) is performed with the ink adhering to the sheet 730, the lower surface 211 of the head 21 will be wiped with the ink. In the present embodiment, at least the nozzle surface 212 of the lower surface 211 of the head 21 is formed of a silicon member, and a water-repellent film is formed on the surface of the silicon member. Thus, the nozzle surface 212 is more easily worn out due to the friction with the sheet 730 than in the case where the nozzle surface 212 is formed of metal. When the ink adheres to the sheet 730, the nozzle surface 212 is more easily worn out than in the case where no ink adheres to the sheet 730.

Moreover, the ink used in the present embodiment is pigment ink that contains titanium oxides or carbon. Since titanium oxide or carbon have hard particles, if the nozzle surface 212 is wiped off with the sheet 730 with such pigment ink adhering thereto, the nozzle surface 212 is especially likely to wear out.

Thus, it is preferable that the cleaning process (step S105) and the wiping process (step S106) are performed under conditions that failing nozzles and the adhesion of the ink to the sheet 730 are less likely to occur.

As shown in FIG. 11B, in the case where the pressure in the nozzle is the wiping pressure P_{w} that is the pressure within an appropriate range for the cleaning process (step S105) and the wiping process (step S106), it is possible to suppress the intrusion of the cleaning liquid or bubbles into the nozzle 200 during the cleaning process (S105) and the adhesion of the ink to the sheet 730 during the wiping process (step S106). As described above, the sheet 730 is in intimate contact with the nozzle surface 212 during the wiping process (S106). Thus, the fiber of the sheet 730 may intrude into the inner surface of the nozzle 200. In the state shown in FIG. 11B, the liquid level (meniscus) of the ink in the nozzle 200 is located above the sheet 730 that may intrude into the inner surface of the nozzle 200, so that the liquid level of the ink and the fiber of the sheet 730 will not come into contact with each other.

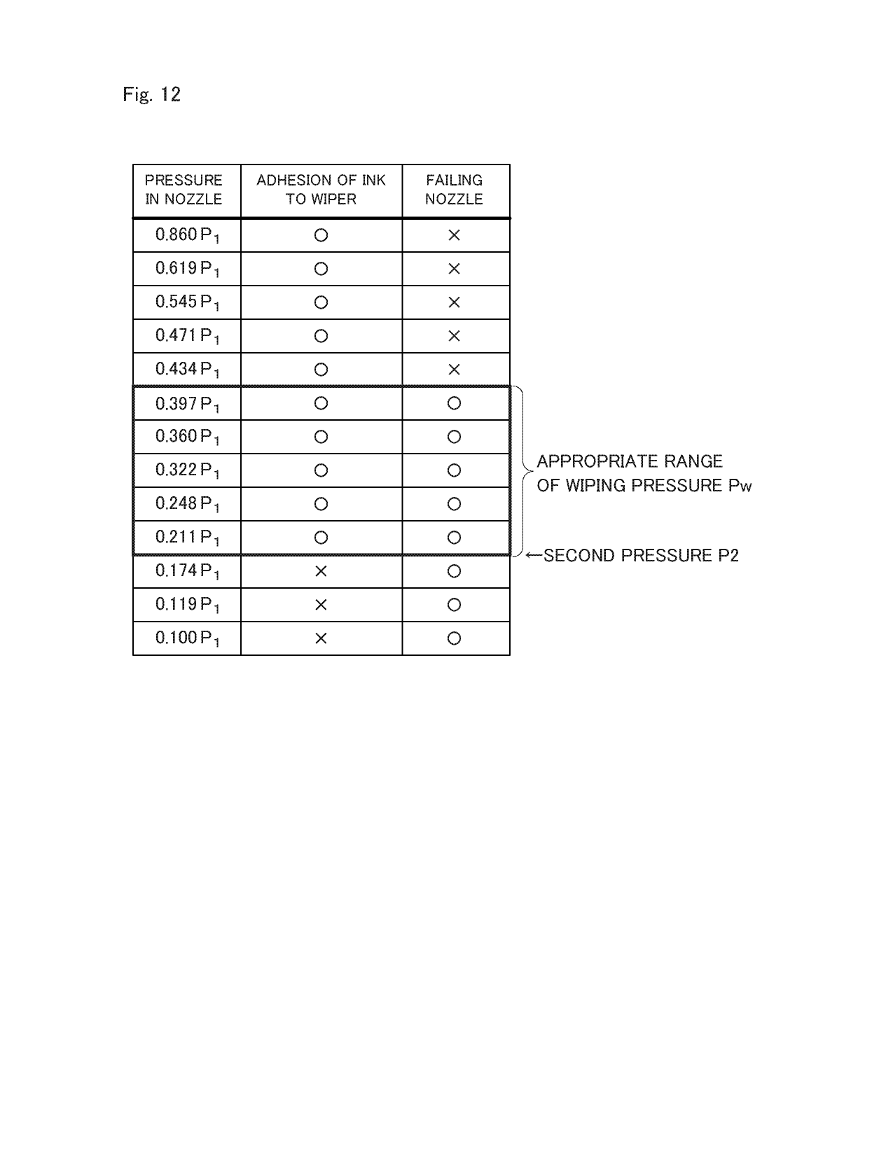

FIG. 12 is a diagram showing the results of experiment in the adhesion of the ink to the sheet 730 and the occurrence of failing nozzles after execution of the cleaning process (step S105) and the wiping process (step S106).

In this experiment, in order to determine the appropriate range of the wiping pressure P_{w}, the printer 9 according to the present embodiment was used to experiment with the adhesion of the ink to the sheet 730 and the occurrence of failing nozzles after execution of the cleaning process (step S105) and the wiping process (step S106) by changing the pressure in the nozzle 200 to various values. Specifically, the experiment was conducted within the range of 0.100P₁ to 0.860P₁ by using, as a reference, the printing pressure P₁ that was the pressure in the nozzle set in the ordinary printing process. Since the printing pressure P₁was a negative pressure, the smaller the coefficient of P₁ in FIG. 12, the higher the pressure (lower the negative pressure), and the greater the coefficient P₁, the lower the pressure (higher the negative pressure).

In FIG. 12, under the heading of “Ink Adhesion to Wiper”, a white circle indicates that the adhesion of the ink to the sheet 730 was not observed visually, and a cross indicates that the adhesion of the ink was observed visually. Under the heading of “Failing Nozzle”, a white circle indicates that no visual streaks were caused by failing nozzles or there were only a few (about five or so) visual streaks in test patterns ejected from all of the nozzles 200, and a cross indicates that there were more than a few visual streaks.

As shown in FIG. 12, the adhesion of the ink to the sheet 730 was not observed in the range of lower than or equal to 0.211P₁. There were only a small number of failing nozzles in the range of higher than or equal to 0.397P₁. From this, it can be said that the range of higher than or equal to 0.397P₁ and lower than or equal to 0.211P₁ is the appropriate range of the wiping pressure P_{w}. In the case where the carry digit is changed, it can be said that the range of higher than or equal to 0.40P₁ and lower than or equal to 0.21P₁ is the appropriate range of the wiping pressure P_{w}.

It can be said from the experimental result shown in FIG. 12 that the second pressure P₂, which is the maximum pressure (lowest negative pressure) that causes the adhesion of the ink to the sheet 730, is within the range expressed by 0.211P₁< P₂< 0.174P₁.

In this way, if the wiping pressure P_{w} is set within the range of higher than the first pressure P₁ and lower than the second pressure P₂, it is possible to suppress the adhesion of the ink to the sheet and the occurrence of failing nozzles during the cleaning process (step S105) and the wiping process (step S106).

In the present embodiment, the cleaning process (step S105) and the wiping process (step S106) are executed continuously. Since there is no need to regulate the pressure in the nozzles between these processes, it is possible to shorten the operating time required for the cleaning process (step S105) and the wiping process (step S106). In the cleaning process (step S105), it is desirable that the wiping pressure P_{w} is set such that the ink is not sucked out from each nozzle 200 against a suction pressure caused by the suction holes of the cleaning block 72.

As described thus far, the printer 9 described above corresponds to one embodiment of the “printer” according to the present invention. In the present embodiment, the head 21, the maintenance unit 70, the controller 90, the nozzles 200, the nozzle surfaces 212, the cleaning block 72, the wiping unit 73, the buffer tank 24, the second to fourth transporters 42 to 44, the supply reservoir 22, the recovery reservoir 23, the third transporter 43, the pump 432, the supply pressure piping 222, the supply pressure regulator 223, the recovery pressure piping 232, the recovery pressure regulator 233, the cleaning-liquid ejection nozzle 737, and the suction holes 722 function as the “printer”, the “head”, the “maintenance unit”, the “controller”, the “nozzles”, the “nozzle surface”, the “cleaning block”, the “wiping unit”, the “ink tank”, the “ink circulation passage”, the “supply reservoir”, the “recovery reservoir”, the “piping”, the “pump”, the “supply pressure piping”, the “supply pressure regulator”, the “recovery pressure piping”, the “recovery pressure regulator”, the “cleaning-liquid ejection nozzle”, and the “suction holes”, respectively.

### 6. VARIATIONS

While one embodiment of the present invention has been described thus far, the present invention is not limited to the embodiment described above.

In the above-described embodiment, the wiper is obtained by wetting the strip sheet 730 with the cleaning liquid, but the present invention is not limited thereto. The wiper may be a sheet such as a dried cloth, or may be a so-called resinous blade .

In the above-described embodiment, the maintenance unit 70 is moved in the width direction relative to the stationary head units 20 during the maintenance process. Alternatively, the head units 20 may be moved in the width direction relative to the stationary maintenance unit 70. That is, the maintenance unit 70 may be moved relative to the head units 20 in the width direction during the maintenance process.

In the above-described embodiment, each head unit 20 has a plurality of heads 21 aligned in a row in the width direction. However, each head unit 20 may have a plurality of heads 21 arranged in two or more rows. Each head unit 20 may also have a plurality of heads 21 arranged in a staggered pattern.

In the above-described embodiment, the printer 9 includes the color printer 931 and the white printer 932. Alternatively, the printer 9 may include only the color printer 931. The number of head units 20 included in the printer 9 may also be different from that in the above-described embodiment.

In the above-described embodiment, the long strip printing medium M is used. Alternatively, the printing medium M does not need to be a long strip and may be an individually cut sheet.

In the above-described embodiment, the cleaning process (step S105) and the wiping process (step S106) are executed while the maintenance unit 70 is moved from the upstream side to the downstream side in the width direction. Alternatively, the cleaning process (step S105) and the wiping process (step S106) may be executed while the maintenance unit 70 is moved in the opposite direction. As another alternative, the contents of the maintenance may be controlled to be changed depending on the direction of travel of the maintenance unit 70 in a manner such as executing both of the cleaning process (step S105) and the wiping process (step S106) when moving the maintenance unit 70 from the upstream side to the downstream side in the width direction and executing only the cleaning process (step S105) when moving the maintenance unit 170 in the opposite direction.

In the above-described embodiment, the upper surface of the cleaning block 72 is brought into close proximity to immediately under the lower surface of each head unit 20 during the ink suction process (step S104) and the cleaning process (step S105). More specifically, the upper surface of the cleaning block 72 is brought into close proximity to immediately under the peripheral surface 290 during the ink suction process (step S104) and the cleaning process (step S105). Alternatively, the upper surface of the cleaning block 72 may be brought into contact with the lower surface of each head unit 20 during the ink suction process (step S104) and the cleaning process (step S105). That is, the upper surface of the cleaning block 72 may be brought into contact with, for example, the peripheral surface 290 or the lower surface 211 of each head 21 during the ink suction process (step S104) and the cleaning process (step S105).

In the above-described embodiment, at least the nozzle surface 212 of the lower surface 211 of each head 21 is formed of a silicon member, and a water-repellent film is formed on the surface of the silicon member. However, the material for the nozzle surface 212 is not limited thereto. For example, the nozzle surface 212 may be formed of a metallic material. As another alternative, the nozzle surface 212 may be formed by covering the surface of the silicon member with a metal plate.

Detailed configurations of the printer may be modified as appropriate without departing from the scope of the aspects of the present application. Besides, each element cited in the above-described embodiment or variation may be combined or omitted as appropriate within the range that does not cause contraction.

The configurations of the preferred embodiments and variations described above may be appropriately combined as long as there are no mutual inconsistencies.

While the invention has been shown and described in detail, the foregoing description is in all aspects illustrative and not restrictive. It is therefore to be understood that numerous modifications and variations can be devised without departing from the scope of the invention.

What is claimed is:

1. A printer that performs inkjet printing on a printing medium, the printer comprising: a head having a plurality of nozzles for ejecting ink; a maintenance unit that performs maintenance of the head; and a controller that regulates a pressure in the head and controls an operation of the maintenance unit, wherein the head has a lower surface that includes a nozzle surface where the plurality of nozzles are provided, the maintenance unit includes: a cleaning block that includes a supplying hole and a suction hole, the supplying hole being a hole through which a cleaning liquid is ejected to the nozzle surface, the suction hole being a hole through which a liquid adhering to the nozzle surface is sucked in; and a wiping unit that includes a wiper that comes in contact with the nozzle surface, in a maintenance process, the controller: a) causes the cleaning block to supply the cleaning liquid to the nozzle surface through the supplying hole and to suck in the liquid adhering to the nozzle surface through the suction hole; and b) causes the wiper to wipe off the nozzle surface after the operation a),the controller keeps a pressure in the nozzle at a predetermined first pressure during a printing process, the controller keeps the pressure in the nozzle at a predetermined wiping pressure during the operations a) and b), and the predetermined wiping pressure is higher than the predetermined first pressure and lower than a second pressure under which the ink adheres to the wiper during the operation b).

2. The printer according to claim 1, further comprising: an ink tank that supplies the ink to the head; and an ink circulation passage in which the ink is circulated between the ink tank and the head, wherein the controller is capable of controlling a flow rate of the ink in the ink circulation passage; the controller continues the circulation of the ink in the ink circulation passage during the printing process; and the controller stops the circulation of the ink in the ink circulation passage during the maintenance process.

3. The printer according to claim 2, further comprising: a supply pressure regulator; and a recovery pressure regulator, wherein the ink circulation passage includes :a supply reservoir that supplies the ink to the head; a recovery reservoir that recovers the ink from the head; piping that connects the recovery reservoir and the supply reservoir; and a pump that is interpolated in the piping and sends the ink from the recovery reservoir to the supply reservoir, the supply pressure regulator communicates with a gas layer formed in the supply reservoir through supply pressure piping and keeps a pressure in the supply reservoir at a predetermined negative pressure for the supply reservoir, the recovery pressure regulator communicates with a gas layer formed in the recovery reservoir through recovery pressure piping and keeps a pressure in the recovery reservoir at a predetermined negative pressure for the recovery reservoir, andthe controller controls the supply pressure regulator and the recovery pressure regulator to average the predetermined negative pressure for the supply reservoir and the predetermined negative pressure for the recovery reservoir and to stop the circulation of the ink in the ink circulation passage by stopping the pump during the maintenance process.

4. The printer according to claim 3, wherein the wiping unit further includes a cleaning-liquid ejection nozzle that ejects the cleaning liquid to the wiper, and the nozzle surface is wiped off with the wiper having the cleaning liquid adhering thereto, during the wiping process.

5. The printer according to claim 4, wherein the wiping pressure is a pressure under which the ink is not sucked in through the nozzle against a suction pressure developed in the suction hole during the cleaning process.

6. The printer according to claim 1, wherein the nozzle surface is formed of a silicon member.

7. The printer according to claim 6, wherein the nozzle surface is a surface obtained by forming a water-repellent film on a surface of the silicon member.

8. The printer according to claim 1, wherein the ink is pigment ink that contains titanium oxide or carbon.

9. The printer according to claim 1, wherein the wiper is biased toward the nozzle surface by an elastic spring during the operation b).

10. The printer according to claim 1, wherein the predetermined wiping pressure is higher than or equal to 0.40P₁ and lower than or equal to 0.21P₁ where P₁ is the predetermined first pressure that is a negative pressure.

11. A maintenance method of performing maintenance of a head in a printer that performs inkjet printing on a printing medium, the maintenance method comprising, under control of the controller: a) causing a cleaning block to supply a cleaning liquid to a nozzle surface and suck in a liquid adhering to the nozzle surface; and b) causing a wiper to wipe off the nozzle surface after the operation a), wherein the nozzle surface is a lower surface of the head where a plurality of nozzles for ejecting ink are provided, a pressure in the nozzle is kept at a predetermined wiping pressure during the operations a) and b), and the predetermined wiping pressure is higher than a first pressure and lower than a second pressure, the first pressure being a pressure in the nozzle during a printing process, the second pressure being a pressure under which the ink adheres to the wiper during the operation b).
